(19) United States
(12) Patent Application Publication
(10) Pub. No.: US 2009/0033162 A1
(43) Pub. Date: Feb. 5, 2009

(54) Variable Inertia Flywheel

(76) Inventor: Patrick J. Dugas, Winter Haven, FL (US)

Correspondence Address: TUCKER LAW OFFICES, 61 RIDGEWAY DR, BROWNSBURG, IN, 46112, US

(21) Appl. No.: 11/833,611

(22) Filed: Aug. 3, 2007

(51) Int. Cl. H02K 7/02

(52) U.S. Cl. 310/74

(57) ABSTRACT

The variable inertia flywheel of the present invention is much simpler than prior art variable inertia flywheels and has very few moving parts. Movement of the liquid mass contained within the flywheel body is accomplished by the centrifugal force and friction of the rotating flywheel. The variable inertia flywheel of the present invention comprises a flywheel body with a liquid chamber disposed around the periphery of the flywheel body. The liquid chamber has an outer wall and an inner wall with one or more symmetrically spaced valves attached to a wall within the liquid chamber, and one or more symmetrically spaced external filling holes for filling a liquid into the liquid chamber. The flywheel body also includes a central hub for mounting the flywheel body to a shaft. Optionally, one or more manually adjustable vanes also may be attached by a central pin to the front and rear surfaces of the liquid chamber of the flywheel body. Optionally, the flywheel also may contain more than one concentric liquid chambers, which may be filled with the same or different liquids. The variable inertia flywheel of the present invention is suitable for use in all applications in which flywheels in general are used.

### TECHNICAL FIELD

This invention relates to flywheels, particularly variable inertia flywheels, and their use in storing and then releasing kinetic energy to meet changing power load demands.

### BACKGROUND OF THE INVENTION

Flywheels are made in a variety of shapes and sizes, and of a variety of materials depending on the application in which the flywheel will be used. A flywheel may be a solid cylinder of any diameter and thickness. Many solid flywheels are thinner near the center of the flywheel and thicker near the perimeter to position the greatest mass at the perimeter of the flywheel. A flywheel also may consist of an outer rim connected to a central hub by spokes. Other configurations of flywheels also have been used. Flywheels may be designed to operate in a horizontal or vertical position. Flywheels generally are constructed of a metal, such as various grades of steel, aluminum, sintered aluminum, and other metals, or of non-metallic materials or composites, such as carbon fiber, carbon/epoxy, fiberglass/epoxy, Kevlar®/epoxy, E-glass/epoxy, and other composites. The configuration of the flywheel and the materials used are determined by the requirements of the application in which the flywheel will be used.

Variable inertia flywheels are utilized in rotation machinery to store energy that may be released quickly to meet a sudden energy demand. Variable inertia flywheels frequently are used with machines that are called upon to do considerable work, but in which the work demand is not constant. Known variable inertia flywheels vary inertia by interconnecting multiple flywheels having different inertia, or by moving a mass connected with the flywheel radially with respect to the axis of rotation. The moveable mass can be a solid or a liquid.

In the case of multiple interconnecting flywheels, complicated gearing and transmission systems are required to control the moment of inertia of each flywheel and transfer the angular momentum from at least one flywheel to an output shaft. Solid masses may be moved slidably toward or away from an axis, for example, by centrifugal force, with a spaced chain pulley having the solid masses attached, other mechanical means, or hydraulic pressure. In the case of a liquid mass, movement generally is facilitated, for example, by use of an electro-mechanical, electromagnetic, oil, or other type pump.

The more moving parts in any apparatus, the greater the chance of failure during operation of the apparatus. In addition, known mechanical and electromechanical devices lack responsiveness when dealing with a sudden increase in demand for power.

### SUMMARY

In contrast to the prior art variable inertia flywheels, the variable inertia flywheel of the present invention comprises a very simple device having few moving parts. The liquid moveable mass incorporated in the present invention is moved by the centrifugal force and friction within the rotating flywheel body.

The flywheel of the present invention has a liquid chamber disposed around the periphery of the flywheel. The liquid chamber is equipped with one or more symmetrically spaced filling holes for introducing a liquid into the chamber and expelling air there from, with corresponding counterweights as appropriate to maintain rotational balance. The liquid chamber also is fitted with one or more symmetrically spaced one-way restriction valves that allow the liquid to flow in the direction of rotation of the flywheel, again with corresponding counterweights as appropriate. When the flywheel encounters increased load conditions and slows its rate of rotation, the movement of the liquid closes the valves and prevents the liquid from slowing down or reversing direction. Thus, the kinetic energy stored in the liquid is released to meet the increased load demand.

Optionally, one or more manually adjustable vanes also may be attached by a central pin to the front and rear surfaces of the liquid chamber of the flywheel in a manner such that the vanes protrude into the liquid chamber at an adjustable angle. The flywheel of the present invention also optionally may contain more than one concentric liquid chambers. The variable inertia flywheel of the present invention is suitable for use in all applications in which flywheels in general are used.

### BRIEF DESCRIPTION OF THE DRAWINGS

FIGS. 1 and 2 are lateral views of the flywheel showing an embodiment of the present invention.

FIGS. 1a and 2a are cross-sectional views of the flywheel showing the embodiments of FIGS. 1 and 2 respectively.

FIGS. 3 and 4 are lateral views of the flywheel showing another embodiment of the present invention.

FIGS. 3a and 4a are cross-sectional views of the flywheel showing the embodiments of FIGS. 3 and 4 respectively.

FIG. 5 shows four types of one-way valves suitable for use in the present invention.

FIG. 6 is a lateral view of the flywheel with optional adjustable vanes in the open position.

FIG. 6a is a lateral view of the flywheel with optional adjustable vanes in a partially closed position.

### DETAILED DESCRIPTION OF THE PREFERRED EMBODIMENTS

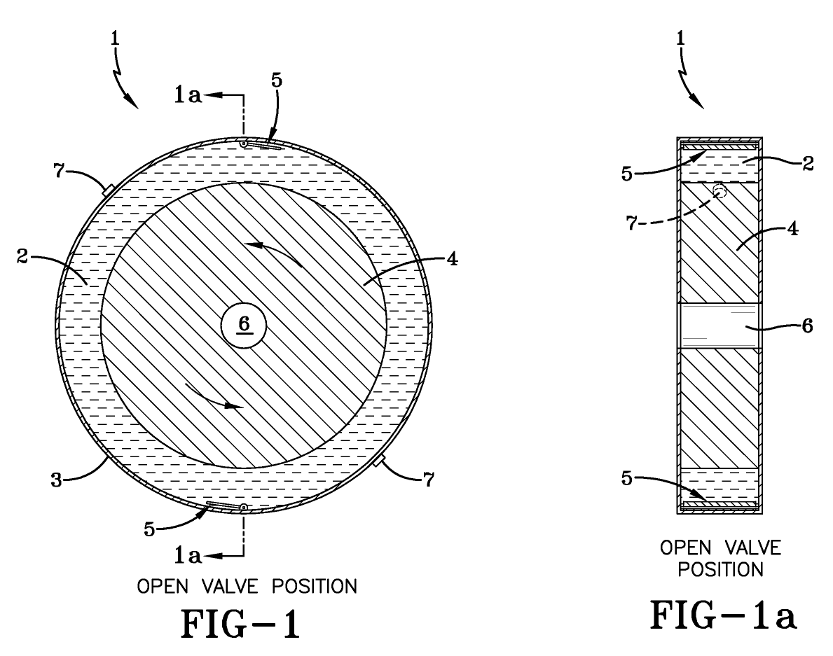

As shown in the Figures, the variable inertia flywheel of the present invention is a very simple device with few moving parts. The flywheel comprises a flywheel body 1 that has a liquid chamber 2 disposed around its periphery. The liquid chamber 2 may be of any convenient shape that will allow the liquid to flow freely within the chamber, for example the circular shape shown in FIG. 1 having a rectangular cross section, or a toroidal or doughnut shape having a circular cross section (not shown in the drawings). The liquid chambers of FIGS. 1 through 4, and 6 have an outer wall 3 and an inner wall 4. One or more symmetrically spaced one-way restriction valves 5 are attached to a wall of the liquid chamber in a manner such that during acceleration of the flywheel body the movement of the valves through the liquid forces the valves open. When the flywheel body reaches constant rotational velocity the liquid will move at the same speed as the flywheel and the valves will remain open. When the flywheel decelerates, for example when additional load is applied to the flywheel body, the movement of the liquid against the valves causes the valves to close so that the liquid now rotates at the same rotational speed as the flywheel body, thus combining the kinetic energy stored in the liquid with that of the flywheel body to meet the additional load demands and maintain the speed of the flywheel. The greater the ratio of the weight of liquid to the weight of solid in the flywheel the greater the efficiency of the flywheel.

The flywheel body also incorporates a central mounting hub 6 for mounting the flywheel on a shaft. A liquid is introduced into the liquid chamber through one or more symmetrically spaced filling holes 7, which are sealed after filling the liquid chamber with liquid. Preferably, the filling holes are threaded and are sealed with bolt headed threaded plugs after filling. However, other methods of sealing the filling holes may be used.

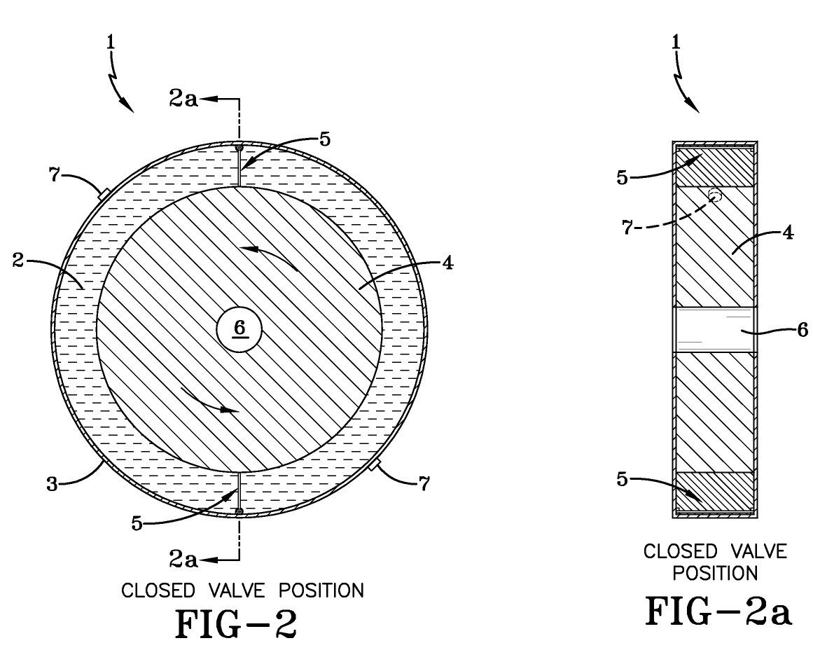

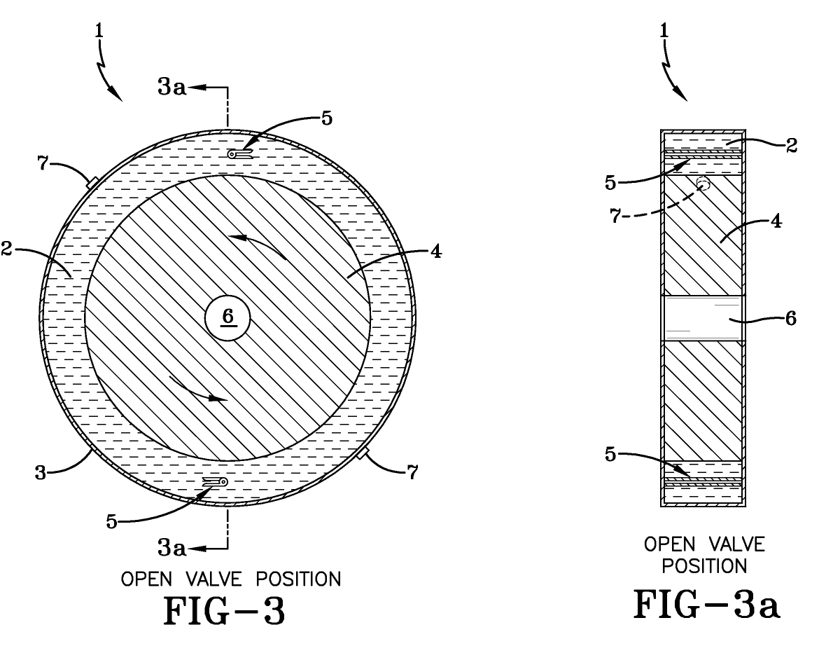

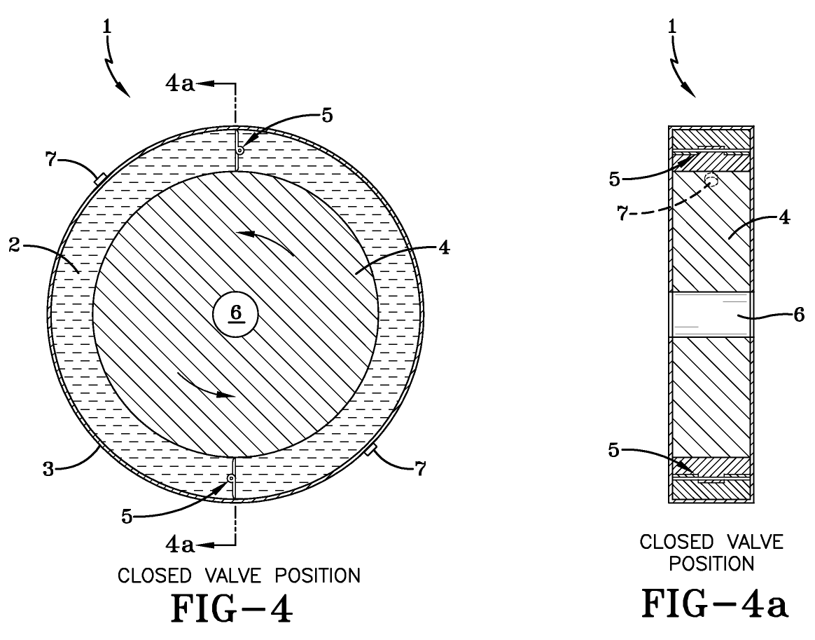

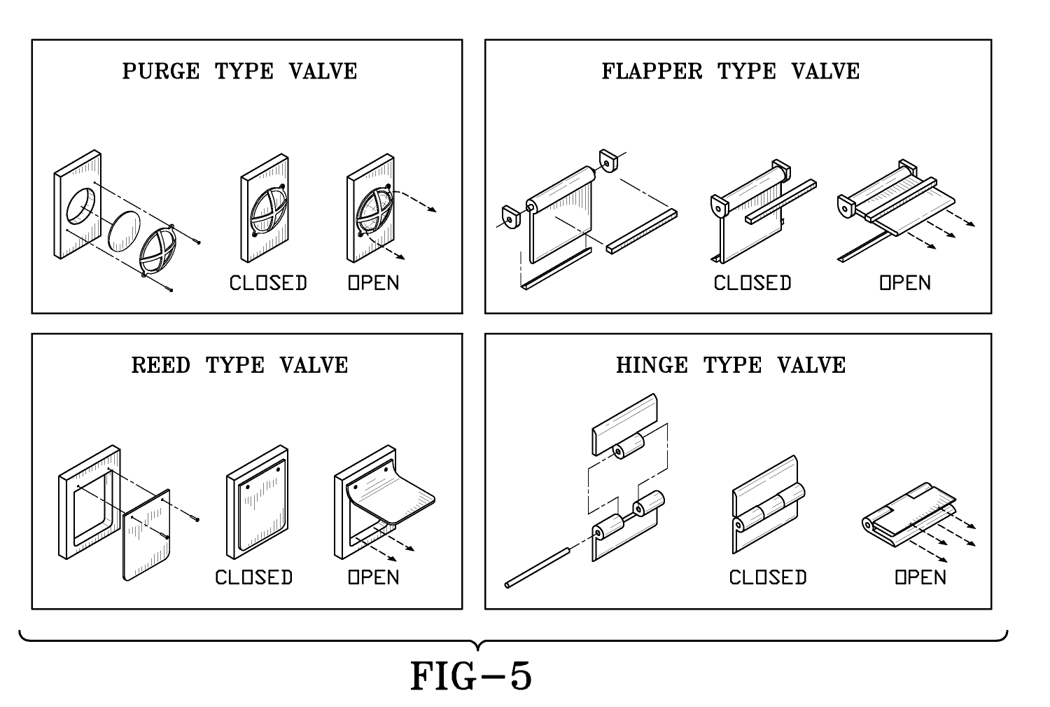

The one-way valves may be of any known configuration. FIGS. 1 and 1a, and 2 and 2a show flapper type valves attached to the inner surface of outer wall 3 of the liquid chamber by a hinge in the open and closed positions respectively. FIGS. 3 and 3a, and 4 and 4a show hinged type valves attached to the front and rear surfaces of the liquid chamber by the hinge pin in the open and closed positions respectively.

The valves may be constructed of any material suitable for the type of valve being used and the application in which the flywheel will be used. For example, a flapper or hinge type valve would be constructed of an inflexible material having sufficient strength to resist the combined mass of the contained liquid. For example, metals, hard plastics, carbon fiber, various composites, or other materials may be used as long as such materials are both inflexible and resistant to the liquid used to fill the liquid chamber. A purge or reed type valve would be constructed of a soft plastic or elastomeric material such as ABS (acrylonitrile butadiene styrene), PVC (polyvinyl chloride), CPVC (chlorinated polyvinyl chloride), PE (polyethylene), PVDF (polyvinylidene floride), or other materials as long as such materials are both flexible and resistant to the liquid used to fill the liquid chamber. Other types of one-way restriction valves also may be used.

During acceleration the flywheel rotates at a greater speed than the liquid and the movement of the valve through the liquid forces the valve open. At a steady rotational speed of the flywheel, the liquid and the flywheel rotate at the same speed and the valve stays open.

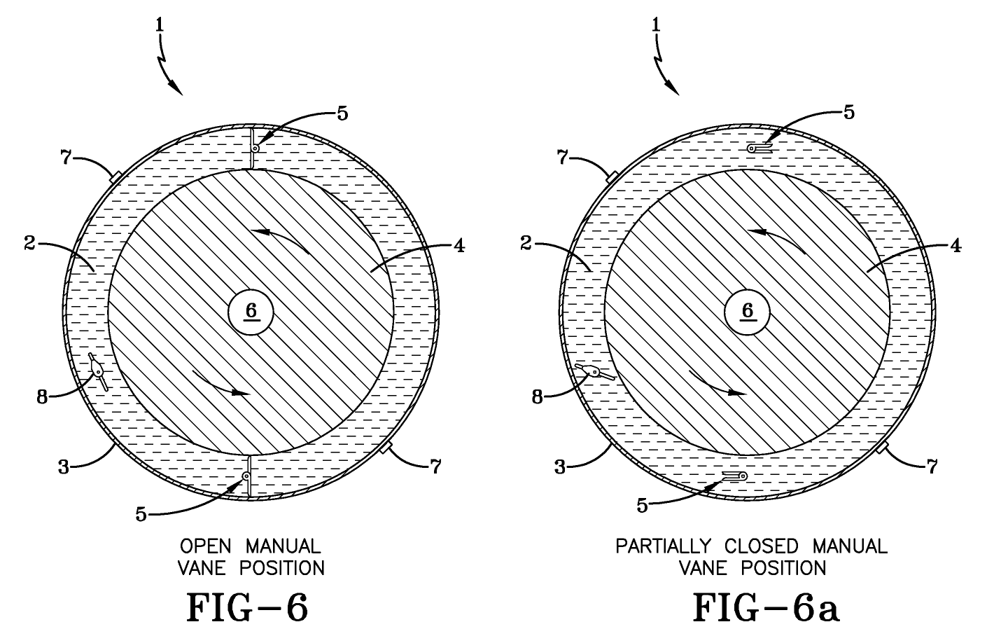

Optionally one of more manually adjustable vanes 8 also may be attached by a central pin to the front and rear surfaces of the liquid chamber of the flywheel body, as shown in FIGS. 6 and 6a. Each vane includes a mechanism for adjusting the angle of the vane within the liquid chamber. This mechanism is accessible from the exterior of the flywheel and comprises a stem that is exterior to the flywheel body and has a knurled knob, paddle shaped blade, or other handle for adjusting the angle of the vane within the liquid chamber. This mechanism also comprises a system for locking the vane at the desired angle within the liquid chamber. The vanes protrude into the liquid chamber at an adjustable angle and push against the liquid at the same speed of rotation as the flywheel itself. Thus, these vanes assist the liquid to accelerate more rapidly to the rotational speed of the flywheel. More rapid acceleration of the liquid is useful in situations where the flywheel body and the liquid need to reach the same rotational speed more rapidly, for example, when it is known that the load on the flywheel will increase soon after the flywheel begins to rotate.

Optionally, the flywheel of the present invention may contain more than one concentric liquid chambers. If each of the concentric chambers holds less liquid than one single chamber, but the total weight of the liquid in both cases is the same, the total liquid in the multiple chamber flywheel will accelerate to the rotational velocity of the flywheel faster than the liquid in the single chamber, because the liquid in the multiple chambers is exposed to a greater surface area, and therefore to greater frictional effects than the liquid in just one chamber. Each of the chambers may be filled with the same liquid or with different liquids.

The flywheel of the present invention having a liquid chamber and one-way valves requires less energy to attain its desired steady rotational speed than a traditional solid flywheel, because the liquid in the liquid chamber slides over the surrounding surfaces as the flywheel begins to rotate requiring significantly less energy for the flywheel to attain optimum speed. Near or at optimum speed the liquid is rotating at the same speed as the flywheel body due to the action of friction and centrifugal forces upon the liquid. A flywheel of the present invention that also has manually adjustable vanes will require a minimal increase in start up energy than a flywheel without the vanes, but will accelerate to the rotational speed of the flywheel more rapidly. Existing traditional flywheels may be retrofitted with an external peripheral liquid chamber and one-way valves, which will significantly increase the stored kinetic energy of the flywheel while requiring only a minimal increase in start up energy.

Suitable liquids for use in the variable inertia flywheel of the present invention are those liquids that are non-corrosive and have a density, coefficient of friction, and viscosity compatible with the material of the flywheel body and the application in which the flywheel body will be used. Water is the least expensive, most readily available and compatible liquid. Water is the preferred liquid. When used with heavy industrial or agricultural equipment, however, heavier liquids, such as Rim Guard® available from RimGuard, Inc., may be more suitable. As an alternative to using only a liquid in the liquid chamber, a suspension of small metal particles in a liquid also may be used in the present invention. The metal particles preferably are of spherical shape, such as small lead shot; and the liquid preferably is water, mineral oil, or other suitable liquid.

The variable inertia flywheel of the present invention is suitable for use in all applications in which flywheels in general are used, for example, with internal combustion engines, continuously variable transmissions, and electrical power generation equipment among others.

Although the variable inertia flywheel of the present invention has been illustrated in the Figures as a flat, solid, cylindrical flywheel, it is understood that the scope of the present invention also includes a flywheel of any known configuration, which may be constructed of any known metal, composite, or other materials, which are suitable for the application in which the flywheel will be used. While the present invention has been described in terms of a general embodiment with several specific modifications, it is recognized that persons skilled in this art will readily perceive many other modifications and variations in the

What is claimed is:

1. A variable inertia flywheel comprising:
a flywheel body;
a liquid chamber disposed around the periphery of the flywheel body;
the liquid chamber having an outer wall and an inner wall;
one or more symmetrically spaced valves attached to a wall within the liquid chamber with appropriate counterbalance as required;
one or more symmetrically spaced filling holes into the liquid chamber with appropriate counterbalance as required; and
a central mounting hub for mounting the flywheel body on a shaft.

2. The flywheel of claim 1 wherein the valves are one-way restriction valves.

3. The flywheel of claim 2 wherein the valves are constructed of a material suitable for the valve type and the specific application for which the flywheel will be used.

4. The flywheel of claim 3 wherein the valves are flapper type or hinge type valves.

5. The flywheel of claim 4 wherein the valves are constructed of metal, hard plastic, carbon fiber, composites, or other materials as long as such materials are both inflexible and resistant to the liquid used to fill the liquid chamber.

6. The flywheel of claim 3 wherein the valves are purge type or reed type valves.

7. The flywheel of claim 6 wherein the valves are constructed of ABS (acrylonitrile butadiene styrene), PVC (polyvinyl chloride), CPVC (chlorinated polyvinyl chloride), PE (polyethylene), PVDF (polyvinylidene floride), or other materials as long as such materials are both flexible and resistant to the liquid used to fill the liquid chamber.

8. The flywheel of claim 1 wherein the liquid chamber is filled with a non-corrosive liquid having a density, coefficient of friction, and viscosity compatible with the material of the flywheel body and suitable for the application in which the flywheel body will be used.

9. The flywheel of claim 8 wherein the liquid is water.

10. The flywheel of claim 8 wherein the liquid is a liquid having a density greater than water.

11. The flywheel of claim 8 wherein the liquid is a suspension of small metal particles in a liquid.

12. The flywheel of claim 1 wherein the filling holes are threaded holes which are sealed with bolt headed threaded plugs.

13. The flywheel of claim 1 optionally including one or more manually adjustable vanes attached by a central pin to the front and rear surfaces of the liquid chamber of the flywheel.

14. The flywheel of claim 13 wherein each manually adjustable vane has a mechanism accessible from the exterior of the flywheel for adjusting the angle of the vane within the liquid chamber.

15. The flywheel of claim 14 wherein each manually adjustable vane also has a system for locking the vane at the desired angle within the liquid chamber.

16. The flywheel of claim 13 wherein the manually adjustable vanes are constructed of metal, hard plastic, carbon fiber, composites, or other inflexible materials.

17. The flywheel of claim 1 optionally having more than one concentric liquid chambers each of which may be filled with the same liquid or with different liquids.
